(19) United States
(12) Patent Application Publication
(10) Pub. No.: US 2026/0127730 A1
(43) Pub. Date: May 7, 2026

(54) Generative Approach for Images Towards Advanced Node Defect Inspection

(71) Applicant: IMEC VZW, Leuven (BE)

(72) Inventors: Bappaditya Dey, Heverlee (BE); Victor M. Blanco, Leefdaal (BE); Vic De Ridder, Lokeren (BE)

(21) Appl. No.: 18/936,662

(22) Filed: Nov. 4, 2024

(51) Int. Cl. G06T 7/00; G06T 5/60; G06T 5/70; G06T 5/77; G06V 10/764; G06V 10/77; G06V 10/774; G06V 10/776; G06V 10/82; G06V 20/70

(52) U.S. Cl. CPC G06T 7/001; G06T 5/60; G06T 5/70; G06T 5/77; G06V 10/764; G06V 10/7715; G06V 10/774; G06V 10/776; G06V 10/82; G06V 20/70; G06T 2207/20081; G06T 2207/20084; G06T 2207/30148; G06V 2201/06

(57) ABSTRACT

The present disclosure describes a generative approach for better semiconductor device defect detection. An example method includes providing an original image set, wherein the original image set comprises a plurality of full-size images. The method also includes extracting one or more patches from the plurality of images, wherein each patch of the one or more patches includes at least a portion of a semiconductor device feature. The method yet further includes classifying each patch as either defect-present or defect-free so as to provide labelled patches that include the semiconductor device feature. The method additionally includes training a denoising diffusion probabilistic model (DDPM) based on the labelled patches and generating, using the trained DDPM, a plurality of synthetic images.

### BACKGROUND

Unless otherwise indicated herein, the materials described in this section are not prior art to the claims in this application and are not admitted to be prior art by inclusion in this section.

As Moore's Law drives the semiconductor industry towards achieving ever-smaller feature sizes (≤10 nm) and increased transistor density, the traditional methods of patterning face challenges. New approaches, including emerging lithography technologies like Extreme-Ultra-Violet-Lithography (EUVL) (≤7 nm), high-NA EUVL (≤2 nm), and other alternatives, are being developed to keep pace with Moore's Law and maintain the relentless pursuit of smaller feature sizes. The escalating complexity of semiconductor devices necessitates a corresponding elevation in process control. This entails the integration of precise metrology, sophisticated data analysis, and cutting-edge defect inspection methodologies. The prevailing state-of-the-art (SOTA) defect detection tools, whether optical or e-beam based, exhibit specific limitations. These tools rely on rule-based techniques for defect classification and detection, which introduces constraints in their adaptability and effectiveness. The use of rule-based approaches implies that these tools are programmed with predefined criteria to identify and classify defects. While this methodology is effective for well-understood and predictable defect patterns, it becomes increasingly challenging when dealing with complex, evolving, or stochastic defects, specifically in the presence of reduced signal-to-noise ratio (SNR) and image contrast.

Due to the inadequacy of rule-based methods at advanced nodes, DL-based object detectors have emerged as the state-of-the-art for stochastic defect inspection. However, the acquisition of a relevant stochastic defect dataset for training ML models faces considerable challenges within the semiconductor manufacturing domain. Not only is such a dataset rare and inherently noisy, but its acquisition is also a costly endeavor. The rarity of stochastic defect instances makes it challenging to compile a comprehensive dataset that accurately represents the diverse range of stochastic defects encountered in real-world semiconductor manufacturing processes. Additionally, two significant bottlenecks further complicate the use of stochastic defect datasets in semiconductor manufacturing defect detection: (a) class imbalance, which arises when certain defect types are underrepresented or occur infrequently in the dataset, leading to a skewed distribution. This imbalance can compromise the model's ability to generalize and accurately detect defects across all classes. (b) insufficient dataset size, as a limited amount of data may not adequately capture the variability and complexity of stochastic defects. The inherent diversity of semiconductor manufacturing processes demands large and representative datasets to ensure the robust training of machine learning models. Addressing these challenges requires innovative approaches to dataset acquisition, including strategic data augmentation techniques to enhance dataset diversity. Collaboration within the industry and the development of shared datasets could also contribute to mitigating the issues associated with rare, noisy, and expensive stochastic defect datasets. Overcoming these challenges is pivotal for advancing the capabilities of machine learning models in semiconductor manufacturing defect detection.

### SUMMARY

Example embodiments utilize Denoising Diffusion Probabilistic Models (DDPM) to generate realistic semiconductor wafer images, thereby increasing defect inspection training data and improving defect inspection performance. Multiple aspects are presented:

i) a patch-based generative framework is proposed that utilizes DDPM to generate SEM images that include intended defect classes with randomly variable instances, aiming to address class-imbalance and data insufficiency bottlenecks. This approach leads to an enhancement in defect detection performance, particularly in terms of precision and recall.

ii) synthetic images are generated that closely resemble real images, preserving actual defect characteristics without the need for prior knowledge of imaging settings under Best-Known-Methods.

iii) a defect detector has been developed and trained on a generated defect dataset, either independently or in combination with a limited real dataset, can achieve a similar or improved mAP on real wafer images during validation/testing compared to when trained exclusively on a real defect dataset. This trend was consistent across three different SEM datasets, validating the capability of DDPM to generate images with characteristics identical to real SEM images.

Finally, iv) the systems and methods described herein demonstrate the capability to transfer defect types, critical dimensions, and imaging conditions from one specified CD/Pitch and metrology specifications to another CD/Pitch and metrology specifications.

In a first aspect, a method is provided. The method includes providing an original image set. The original image set includes a plurality of full-size images. The method also includes extracting one or more patches from the plurality of images. Each patch of the one or more patches includes at least a portion of a semiconductor device feature. The method also includes classifying each patch as either defect-present or defect-free so as to provide labelled patches that include the semiconductor device feature. The method yet further includes training a denoising diffusion probabilistic model (DDPM) based on the labelled patches. The method additionally includes generating, using the trained DDPM, a plurality of synthetic images.

In a second aspect, a method for training a defect detector is provided. The method includes generating, using a trained denoising diffusion probabilistic model (DDPM), a plurality of synthetic images. The trained DDPM was initially trained on a plurality of patches extracted from full-size images. The method also includes training a defect detector with the plurality of synthetic images so as to detect defects within input images.

In a third aspect, A method for detecting defects in semiconductor devices is provided. The method includes receiving at least one full-size image. The method additionally includes determining, using a trained defect detector, whether a defect is present in the image. Trained defect detector was trained using a plurality of synthetic images generated from a trained denoising diffusion probabilistic model (DDPM). The method also includes classifying, using the trained defect detector, the image as either defect-present or defect-free. The method additionally includes, if a defect is present in the image, classifying the defect as having a defect type from among a set of possible defect types.

Other aspects, embodiments, and implementations will become apparent to those of ordinary skill in the art by reading the following detailed description, with reference where appropriate to the accompanying drawings.

### BRIEF DESCRIPTION OF THE FIGURES

FIG. 1 illustrates representative sample SEM images illustrating example defect types, according to an example embodiment.

FIG. 2 illustrates a block diagram for synthetic SEM image dataset generation containing multiple defects, according to an example embodiment.

FIG. 3 illustrates a block diagram for generating full-size, defect-free SEM archetype images using a patch based method, according to an example embodiment.

FIG. 4 illustrates a table of diffusion model hyperparameters, according to an example embodiment.

FIG. 5 illustrates a comparison between (a) real SEM image, (b) image generated with software simulation, and (c) synthetic image, according to an example embodiment.

FIG. 6 illustrates a linescan plot for a synthetic image and a real SEM image, according to an example embodiment.

FIG. 7 illustrates examples of synthetic defect instances and real SEM images of same defect type, according to an example embodiment.

FIG. 8 illustrates inference results for real (top), and synthetic (down) images, according to an example embodiment, according to an example embodiment.

FIG. 9 illustrates statistics of real and synthetic training datasets, according to an example embodiment.

FIG. 10 illustrates AP and AR scores achieved on a real ADI test dataset, according to an example embodiment.

FIG. 11 illustrates AP and AR scores achieved on a real AEI test dataset, according to an example embodiment.

FIG. 12 illustrates AP and AR scores achieved on a real HEXCH-DSAtest dataset, according to an example embodiment.

FIG. 13 illustrates mAP and mAR scores achieved on real test data, according to an example embodiment.

FIG. 14 illustrates a framework that can generate defect types outside its typical process parameters, to prepare defect detectors for unexpected scenarios, according to an example embodiment.

FIG. 15 is an SEM image with a line collapse defect, according to an example embodiment.

FIG. 16 illustrates several different defects from the LS-ADI test dataset, according to an example embodiment.

FIG. 17 illustrates several different defects from the LS-AEI test dataset, according to an example embodiment.

FIG. 18 illustrates several different defects from the HEXCH-DSA test dataset, according to an example embodiment.

FIG. 19 illustrates the defect detection and classification process, according to an example embodiment.

FIG. 20 illustrates a method, according to an example embodiment.

FIG. 21 illustrates a method, according to an example embodiment.

FIG. 22 illustrates a method, according to an example embodiment.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. Other embodiments can be utilized, and other changes can be made, without departing from the scope of the subject matter presented herein.

Thus, the example embodiments described herein are not meant to be limiting. Aspects of the present disclosure, as generally described herein, and illustrated in the figures, can be arranged, substituted, combined, separated, and designed in a wide variety of different configurations, all of which are contemplated herein.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

### I. Overview

As semiconductor technology advances in accordance with Moore's Law, the continuous reduction in feature sizes present an escalating challenge in defect detection. The limitations imposed by optical and e-beam technologies further contribute to the complexity of identifying defects at these shrinking scales, owing to increasing noise and decreasing image contrast levels. Precision in identifying nanometer-scale device killer defects is crucial in both semiconductor research and development as well as in production processes. The effectiveness of existing machine learning-based approaches in this context is largely limited by the scarcity of data, as the production of real semiconductor wafer data for training these models involves high financial and time costs. Moreover, the existing simulation methods fall short of replicating images with identical noise characteristics, surface roughness and stochastic variations at advanced semiconductor nodes. The methods and systems described herein relate to generating synthetic images using a diffusion model within a limited data regime. In contrast to images generated through conventional software simulation methods, images generated through the disclosed deep learning method closely resemble real images (e.g., scanning electron microscope (SEM) images, and adaptively replicate their noise characteristics and surface roughness.

Example embodiments utilize a Denoising Diffusion Probabilistic Model (DDPM), which is type of generative model used to form high-quality images from a given distribution of data. DDPMs work by gradually converting random noise into a structured image through a process called “diffusion,” which consists of many small steps.

The process can be divided into two main phases: 1) Forward process (Diffusion) and 2) Reverse process (Denoising).

In the Forward process, the model gradually transforms data from its original form into pure noise through a predefined series of steps, each adding a small amount of noise.

Initialization: Start with an original data sample x₀, which could be an image or any other kind of structured data.

Noise Addition: At each step t the model adds Gaussian noise to the data based on a variance schedule βₜ. This schedule dictates how much noise to add at each step and provides the gradual transition from data to noise.

Progression: The noisy data at each step can be represented as xₜ, where xₜ is increasingly noisier than xₜ₋₁. The process continues until x_{T} is nearly indistinguishable from pure noise. Mathematically, this can be modeled as: xₜ=\sqrt{1−βₜ}xₜ₋₁+\sqrt{βₜ}ϵ where ϵ is the random noise drawn from a Gaussian distribution.

In the Reverse process, starting from the noise, the model attempts to recreate the original data by reversing the noise addition process.

Starting Point: Begin with x_{T}, which is essentially random noise.

Denoising Step: At each step t, the model predicts the noise \hat{ϵ}ₜ that was added at step t of the forward process. This prediction is based on the noisy data at that step, xₜ.

Noise Removal: Using the predicted noise, the model computes the less noisy state

$${x}_{t - 1} as : {x}_{t - 1} = \frac{1}{\sqrt{1 - {β}_{t}}} ( {x}_{t} - \sqrt{{β}_{t}} {\hat{ϵ}}_{t} )$$

Iterative Reconstruction: This step is repeated, moving backward through the steps until x₀, the denoised image resembling the original data, is recovered.

The key component of the reverse process is a neural network trained to predict the noise \hat{ϵ}ₜ accurately. The network learns this by minimizing the difference between the actual noisy data at each step and the data reconstructed by removing predicted noise.

Put another way, the model is trained by running the forward process to generate noisy versions of training data, then training the neural network to perform the reverse process effectively. The objective is to minimize errors in noise prediction, which translates into more accurate reconstructions of the original data in the reverse process. The output quality of DDPMs is quite high, making them useful for tasks like image generation, enhancement, and restoration.

Several aspects of the presently disclosed embodiments have been validated on multiple different real semiconductor datasets, including: i) development of a patch-based generative framework utilizing DDPM to create images (e.g., scanning electron microscope (SEM) images) with intended defect classes, addressing challenges related to class imbalance and data insufficiency; ii) the ability to generate synthetic images closely resembling real images acquired from the tool, preserving all imaging conditions and metrology characteristics without any metadata supervision; iii) development of a defect detector trained on generated defect dataset, either independently or combined with a limited real dataset, that can achieve similar or improved performance on real wafer images during validation/testing compared to exclusive training on a real defect dataset; and iv) the ability of the present methods and systems to transfer defect types, critical dimensions, and imaging conditions from one specified CD/Pitch and metrology specifications to another, thereby highlighting its versatility.

Other benefits of the described defect inspection framework include: 1) a robust method based on synthetic images generated under varying conditions; 2) concurrent training using different processes and associated defect types; and 3) generation of defect types outside of typical process parameters to prepare the defect detectors for unexpected scenarios.

While embodiments described herein may relate to scanning electron microscope (SEM) images, it will be understood that other types of images are possible and contemplated within the context of the present disclosure. For example, various other types of images are possible, such as transmission electron microscope (TEM) images, field emission microscope (FEM) images, atomic force microscope (AFM) images, scanning tunneling microscope (STM) images, among other possibilities.

### II. Example Generative Framework for SEM Imaging of Semiconductor Defects

Example systems and methods utilize a DDPM-based framework to generate full-scale wafer images at advanced IC pattern dimensions. The systems and methods generate synthetic SEM images with intended stochastic defect classes, including multiple instances of these defect classes, that closely resemble real resist-wafer images collected from imaging tools (e.g., a scanning electron microscope (SEM)). This is achieved while preserving the characteristics such as Line Edge Roughness (LER) and Line Width Roughness (LWR) of real images, with the goal of enhancing defect detection performance.

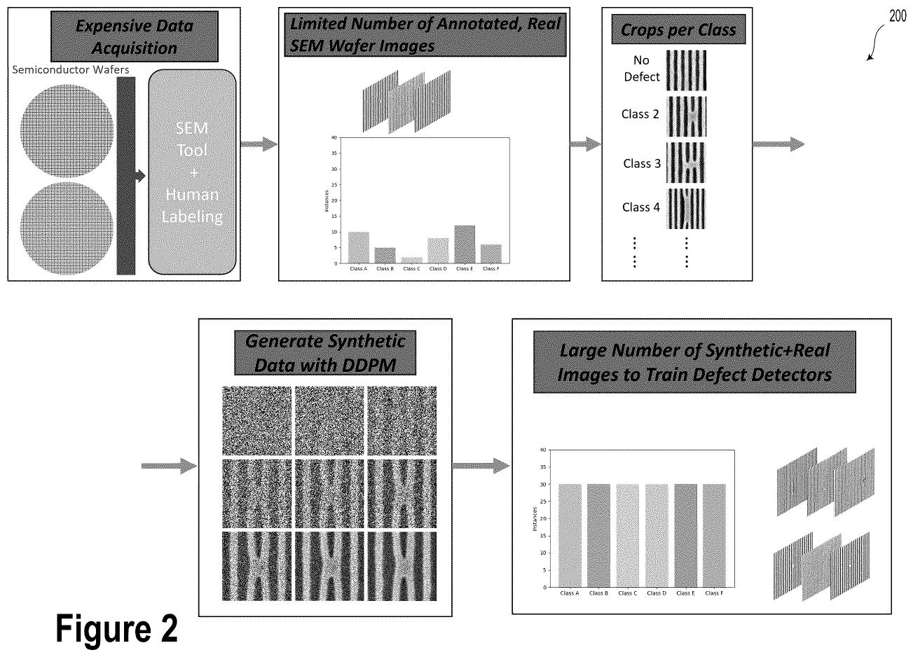

Example embodiments leverage DDPM as a generative tool to solve the problem of low data availability in semiconductor defect inspection application. The presently described approach does not directly train the diffusion model on the real images of defects. Instead, various small patches are extracted from the original images. Each patch has a class label as either the defect type present inside the patch, or background (defect-free). The DDPM model is then trained in a class conditional manner on these patches. FIG. 2 depicts an example method for generating synthetic realistic image dataset containing multiple defect types.

Although example embodiments specifically reference images from a scanning electron microscope (SEM) tool, it will be understood that other types of image sources and formats are possible and contemplated. Without limitation, methods and systems described herein could operate using images (and/or image patches) from transmission electron microscope (TEM), atomic force microscope (AFM), scanning force microscopy (SFM), field emission microscopy (FEM), among other possibilities. Additionally, it will be understood that the image file type and/or format may vary. For example, .TIFF, .JPG, .BMP, and/or .PNG image file formats are possible and contemplated.

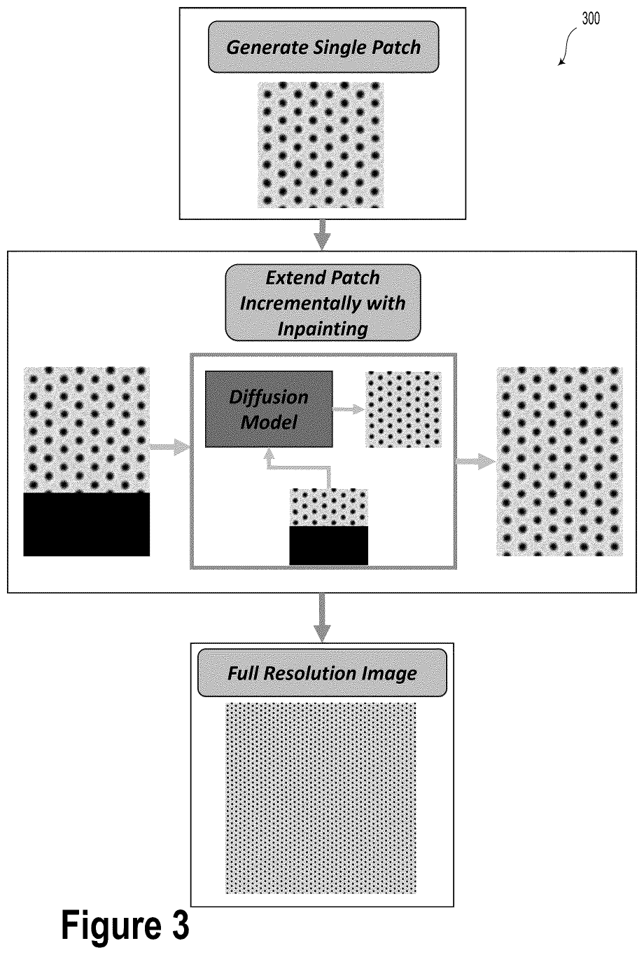

FIG. 3 illustrates a block diagram for generating full-size, defect-free SEM archetype images using a patch based method, according to an example embodiment. After training the DDPM model, synthetic images are generated using an inpainting procedure. The method displayed in FIG. 3 is used to generate full-size, defect-free, synthetic images. Afterwards, crops of these full-size images are inpainted to simulate intended defect types, resulting in the final synthetic images containing defects.

This patch-based approach offers three advantages over training directly on full-size images: i) significantly reduced training time. ii) control over the number of defects in the generated images, enabling the generation of full-scale images with defect numbers not present in the real image dataset. iii) Training on patches results in larger datasets, thereby enhancing the learning process.

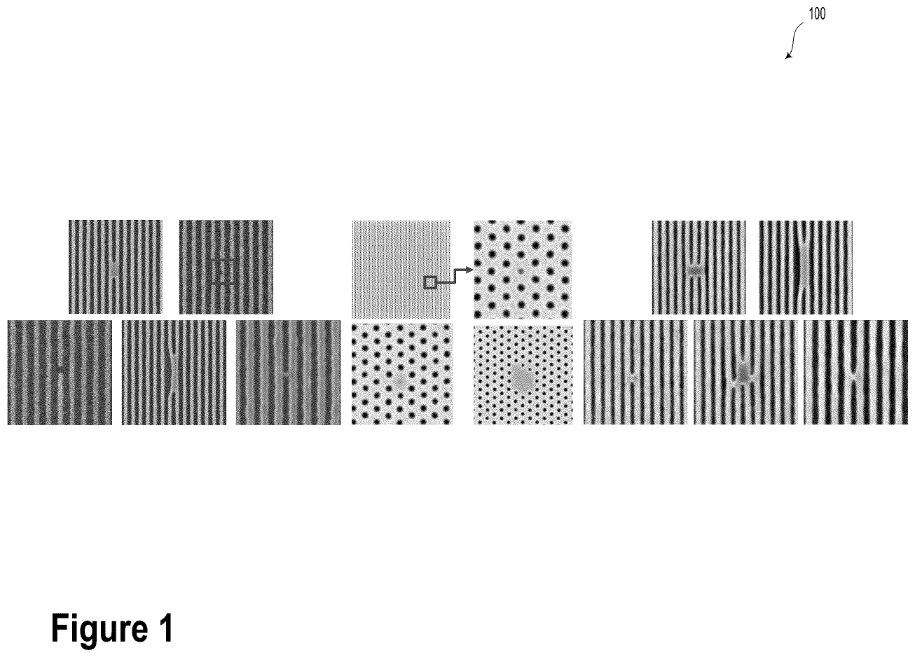

The described approach has been validated using three semiconductor SEM image datasets: Hexagonal Contact-Hole arrays (HEXCH-DSA), Line-Space After Develop Inspection (LS-ADI), and Line-Space After Etch Inspection (LS-AEI). Each of these contains only real SEM wafer images, and no defects are synthetic or intentionally placed. The different defect types are demonstrated in FIG. 1 for each dataset as: i) partially closed hole, missing hole, and closed patch for HEXCH-DSA, ii) gap, probable gap, bridge, microbridge, linecollapse for LS-ADI, and finally iii) thin bridge, single bridge, line collapse, multi bridge horizontal, and multi bridge non-horizontal for LS-AEI.

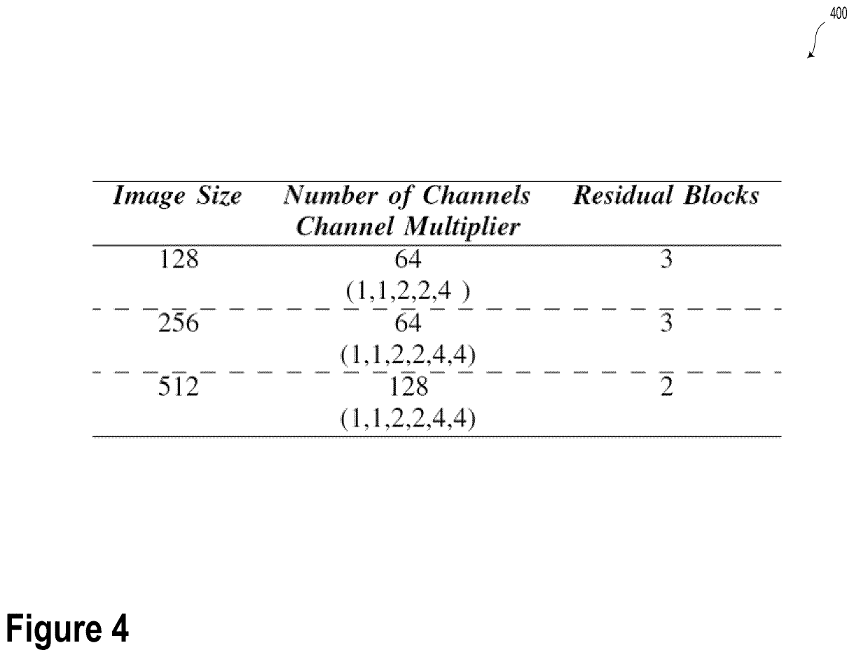

The diffusion model used in this work utilizes a cosine noise schedule and 1000 sample steps. It will be understood that another number of sample steps is possible and contemplated. For example, the diffusion model could utilize between 100 to 100,000 or more sample steps. On each real dataset, the model is trained using a learning rate of between 0.001 and 0.00001 (e.g., 0.0001) until convergence. In some scenarios, the number of sample steps and/or the learning rate could be adjusted, selected, and/or determined based on, for example, noise behavior, magnitude of noise, imaging conditions, field of view, image resolution, illumination level, contrast level, relative ease of feature training, among other possibilities. The inpainting functionality has been added without resampling steps. Example models may be trained on a default image size of 128 pixels. However, some defect types such as linecollapse or closed patch exceed this limit. Thus, a separate model can be trained on larger image sizes to generate these defect types. FIG. 4 illustrates a table of diffusion model hyperparameters, according to an example embodiment.

The defect detector may be trained on three datasets (LS-ADI, HEXCH-DSA, LS-AEI) under different configurations (real, synthetic, combined). Due to its fast training time, YOLOv5n can be utilized as a defect detector to validate the use of generated synthetic images in training object detectors. In some examples, each model may be initialized from COCO pretrained weights, trained for 200 epochs with batch size of 32, and with early stopping criteria enabled. The weights with best performance on the validation dataset are selected for use in subsequent runs. In some embodiments, the defect detector could be trained from scratch. It will be understood that other object detector models are possible. As an example, the defect detector model could include the YOLO family, v3, v4, . . . v10; ResNet 101, 152; and/or Visual Geometry Group (VGG) 16, 19, etc. Furthermore, other one stage or two stage object detectors could be utilized based, for instance, on the specific imaging application and requirements. One-stage object detectors, which can directly predict the presence and locations of objects within an image in a single shot, are mainly faster than two-stage models. An example of a one-stage object detector includes Single Shot MultiDetector (SSD). Two-stage models, which may include a region proposal step and a classification and bounding box regression step, are generally more accurate than one-stage models. Examples of two-stage object detector models include R-CNN, Fast R-CNN, and/or Faster R-CNN. In some example embodiments, the generated synthetic images can be used as training data for any other type of object detector model. In some examples, the defect detector could include an object detection model that utilizes a cross stage partial (CSP) network. However, it will be understood that methods described herein could utilize an object detection model (e.g., a one- or two-stage object detection model) that need not include a CSP network.

To utilize synthetic images in training supervised defect detectors, such as YOLO, they must first be annotated/labelled. The systems and methods described herein label the synthetic images by applying a defect detector already trained on real data. However, training defect detectors on synthetic data poses an additional challenge, as it may yield worse predictions compared to human annotation.

This challenge arises due to two reasons: i) Synthetic images lack sufficient resemblance to the original data, and ii) Labeling errors in synthetic training data result in suboptimal learning signals, affecting performance on real test data. However, the described approach actually shows that generated synthetic images and associated labeling quality improved or performed as per on defect detection task.

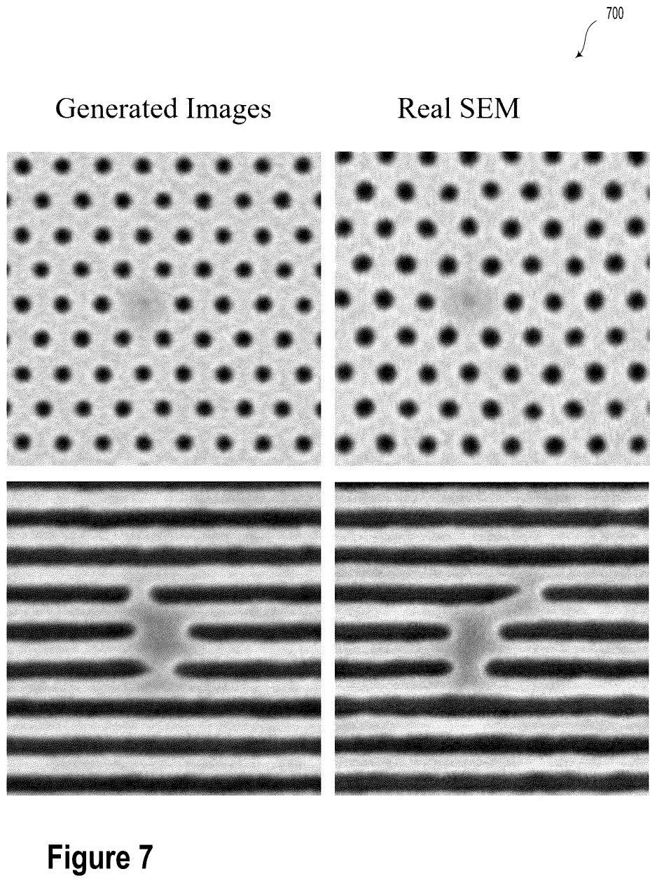

Synthetic images generated by the proposed DDPM-based approach are evaluated qualitatively. First, visual comparison does not yield any differentiating characteristics between synthetic defects (FIG. 7) and those obtained from SEM tools (validated with several anonymous SEM image experts). Beyond visual comparison, line-edge-roughness and critical dimension (CD) are crucial metrology parameters in semiconductor patterning, towards validating device electrical characteristics and performance. To generate synthetic or artificial images, with or without defects, using conventional software such as ARTIMAGEN, it is essential to be aware of industry Best-Known-Methods (BKM) settings to comply with tool imaging conditions. Without appropriate values for parameters like pixel size, number of frames in acquisition, accelerating voltage, probe current, etc., it becomes quite challenging to generate synthetic images that closely resemble real images. Additionally, using incorrect parameter values can introduce digital artifacts into the synthetic images, rendering them unsuitable for ML model training and, consequently, compromising the preservation of original device characteristics.

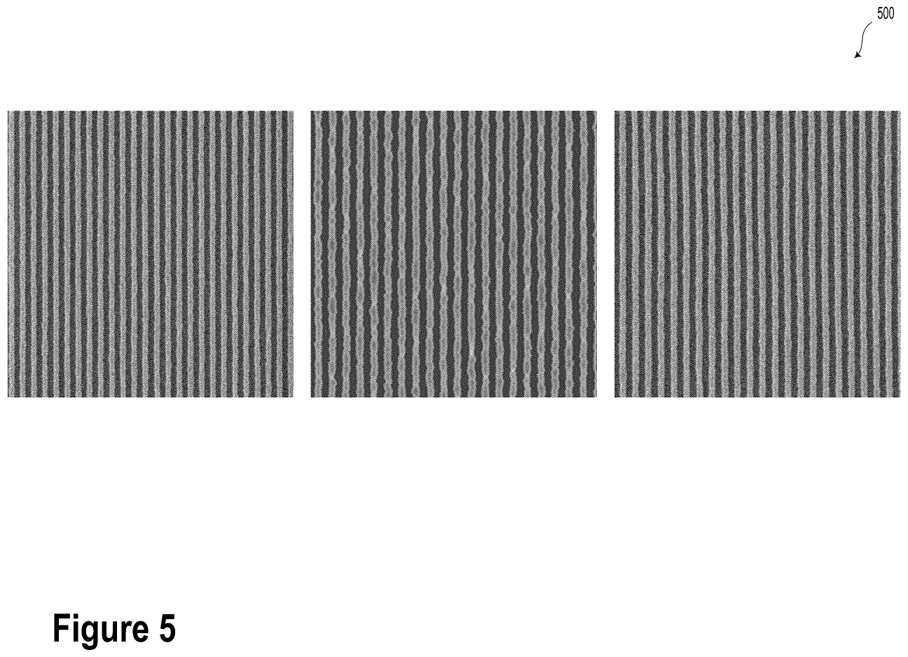

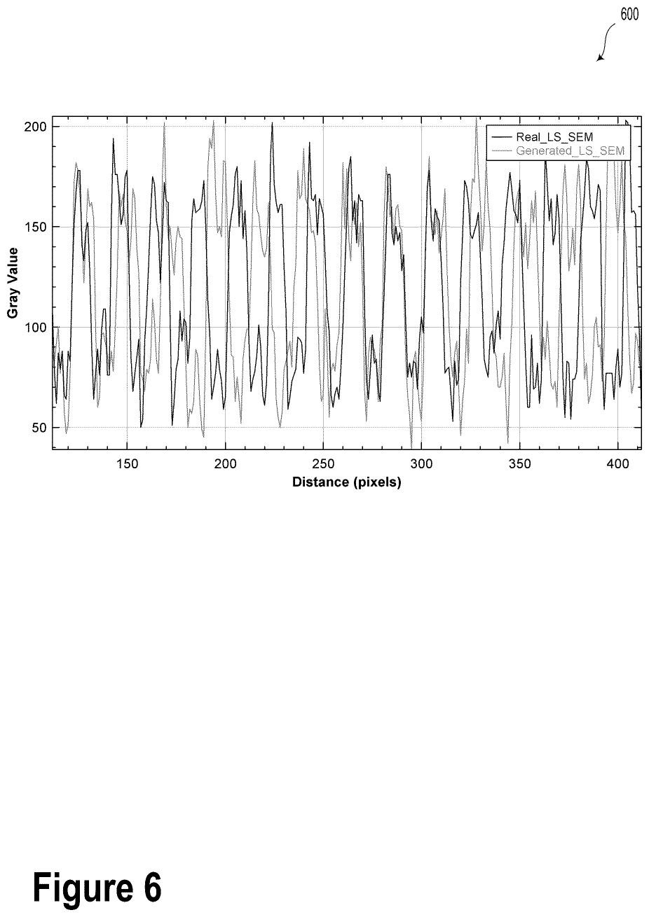

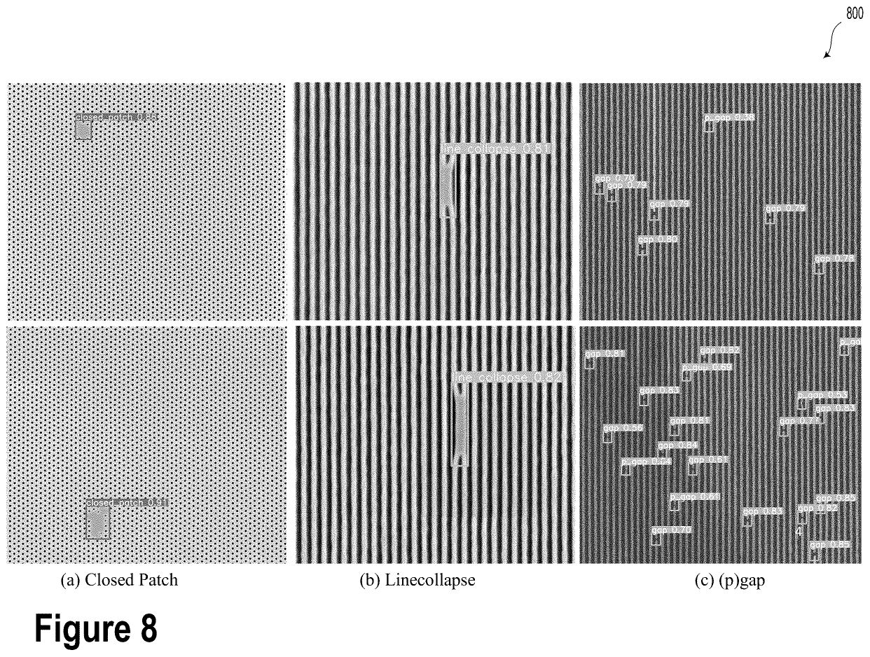

Contrary to this, our proposed approach generates synthetic images that closely resemble real images and preserve actual characteristics without requiring prior knowledge of BKM settings, as shown in FIG. 5. FIG. 6 shows the line-scan plots of generated (by the presently-described approach) and real SEM image (for Line-Space feature), which can be used to compare CD and roughness parameters between these two. Lastly, FIG. 8 presents inference results on generated synthetic and real images (test set) from a defect detector trained solely on real data. Both the inference confidence and classification accuracy on semantic contexts (such as probable gap and gap), as well as the line-scan plots of original and synthetic data (for linespace feature), appear nearly identical. This strongly indicates that generated synthetic images are sufficiently similar to the original data, supporting their use in expanding the size of the semiconductor defect inspection dataset.

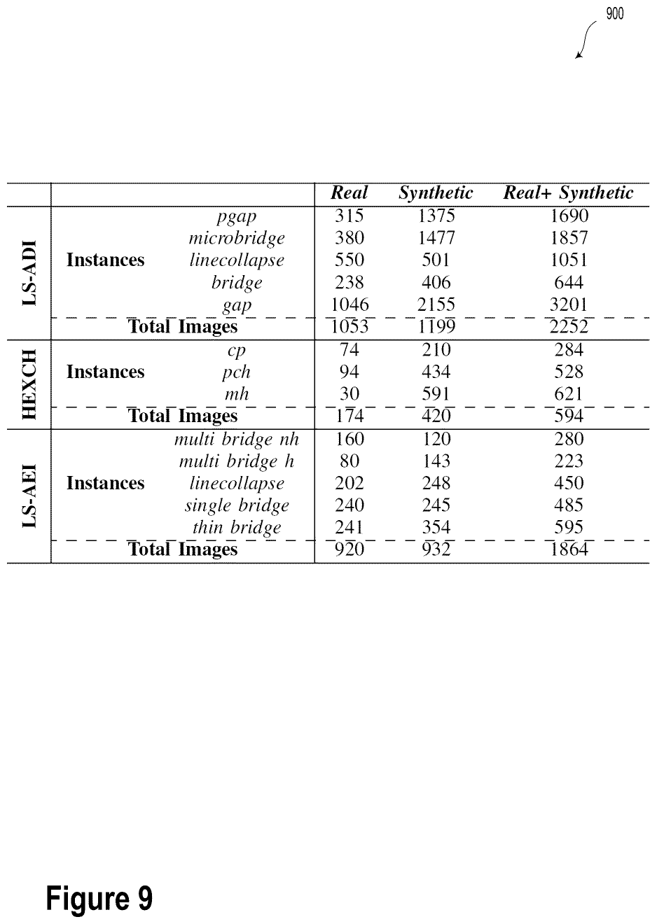

Synthetic images generated with the proposed approach can be successfully used in training defect detectors. Defect detectors have been trained with generated synthetic counterparts of each investigated dataset in two configurations as: (1) with synthetic dataset only and, (2) combined with real dataset. Statistics of real and synthetic datasets are shown in FIG. 9.

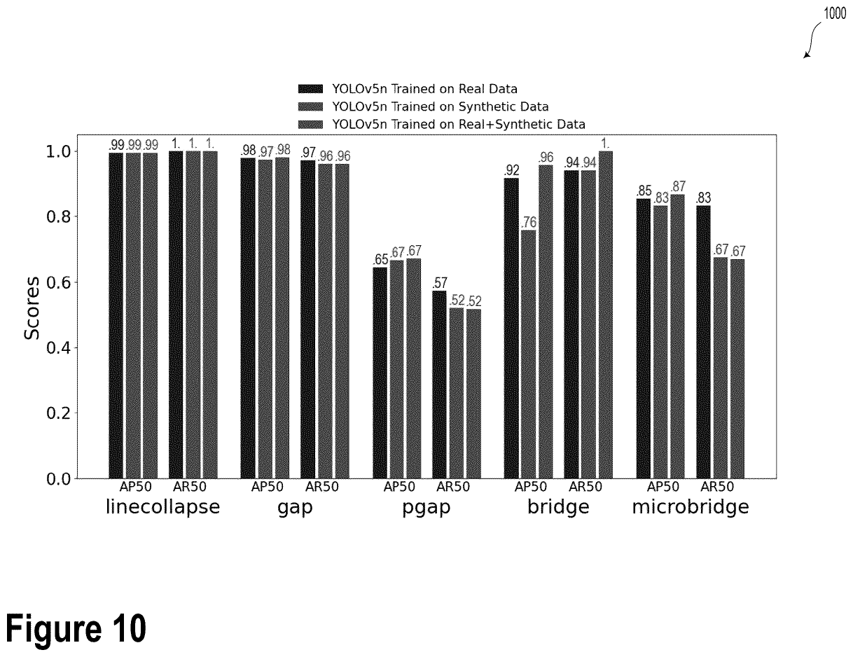

FIG. 10 shows the AP and AR scores per defect class on LSADI real test dataset, achieved by YOLOv5n model trained on either real, synthetic, or combined datasets. While some deviations and deficits are present, no major performance drops are observed when training on synthetic data. Thus, the proposed DDPM approach generates images based on the LSADI dataset, which can be properly utilized for training defect detectors, as no major performance deficits are encountered when switching from training on real data, to training only on synthetic data. Training only on the combination of the real and synthetic dataset does not yield any performance gains, despite the larger size of the combined dataset.

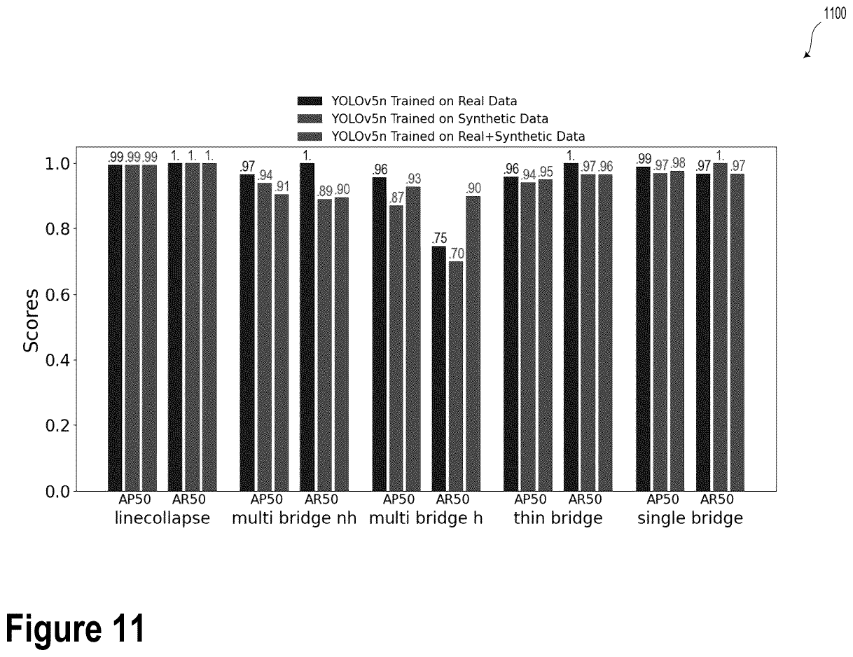

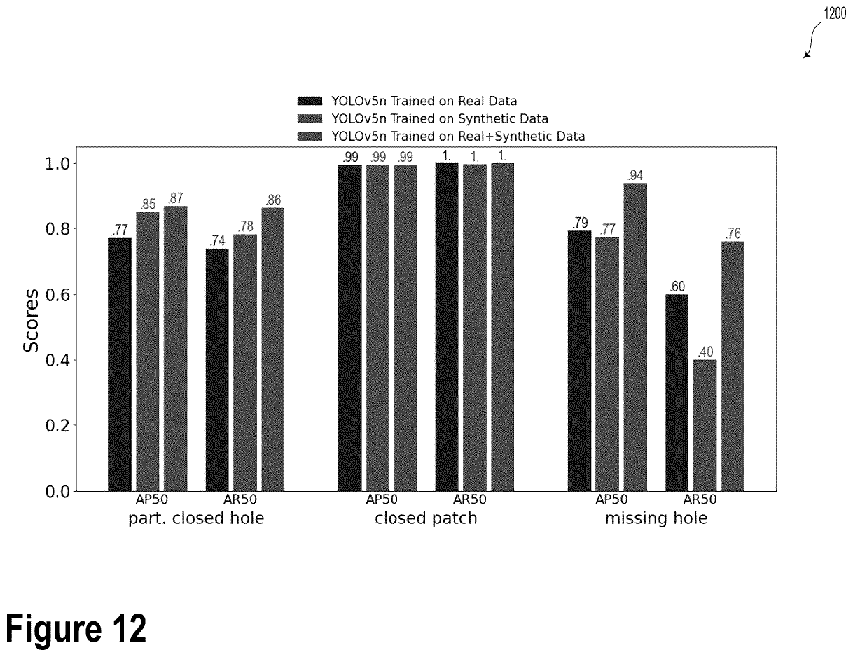

FIG. 11 shows the AP and AR scores per defect class on LS-AEI real test dataset by model trained on real, synthetic or combined datasets. A scenario similar to the LS-ADI is observed, where training on the synthetic dataset does not lead to major performance deficits. Finally, FIG. 12 shows the AP and AR scores on HEXCHDSA real test dataset by model trained on the different dataset configurations. On HEXCH test data, a definite performance improvement has been observed when model is trained on the combined synthetic+real dataset. HEXCH dataset may be significantly smaller in size compared to the other two datasets (See FIG. 9). This may explain that, while model did not benefit from training on synthetic+real data for LS datasets, the model significantly benefited for HEXCH-DSA dataset, as combining both synthetic and real data increased the dataset size (without altering real characteristics of the image/defect features) to properly learn the required defect features.

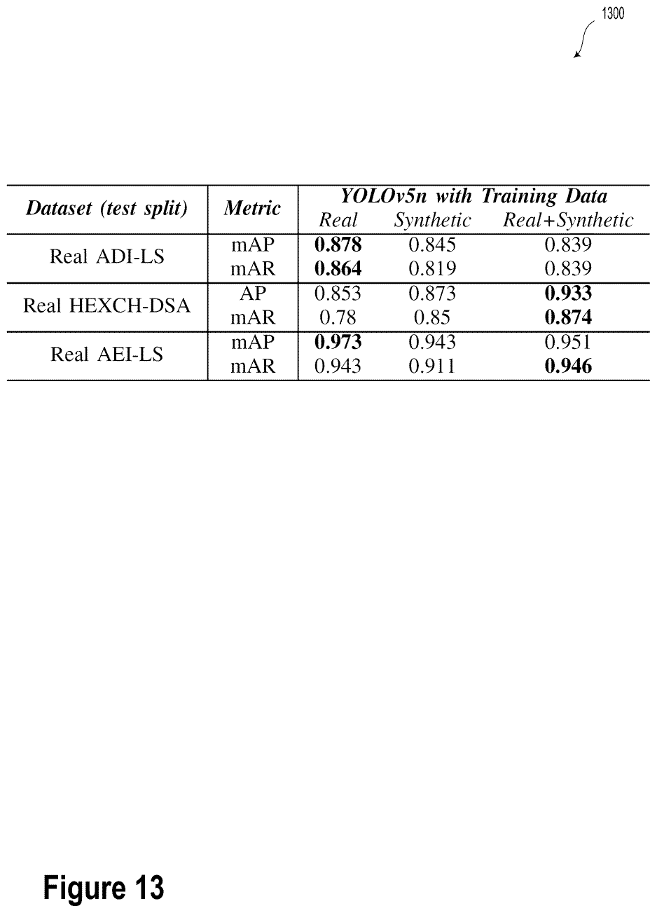

FIG. 13 shows the mAP and mAR scores achieved on the different real SEM test datasets, for different training dataset configurations. This table summarizes that, while training only on synthetic data does not provide clear benefits in all scenarios, it never causes significant performance drops, against training only on real dataset. This validates that the synthetic images generated by proposed method can have valid usage in training defect detection models, by replacing or combining with real SEM images datasets for different process steps.

Wafer images can vary significantly depending on factors such as dose/focus used, design geometrical patterns, critical dimension, resist profiles, or underlayers. Consequently, significant numbers of images have to be acquired and labelled for each set/combination of process parameters to train a defect detection model. Furthermore, as defect types are stochastic in nature, two challenging scenarios may occur quite frequently, as (i) a given defect type/class has a very small probability to occur in that process while training defect detection models (class imbalance), or (ii) relevant defect images dataset to train a model is not just rare and noisy, but also very expensive to get (limited training dataset size).

In these cases, without sufficient images of certain defect types available at a certain process step, deploying an industry-compliant ML-based defect detection framework may be problematic, as overall model convergence cannot be guaranteed towards generalizability and robustness due to model's underfitting for those defect type's features.

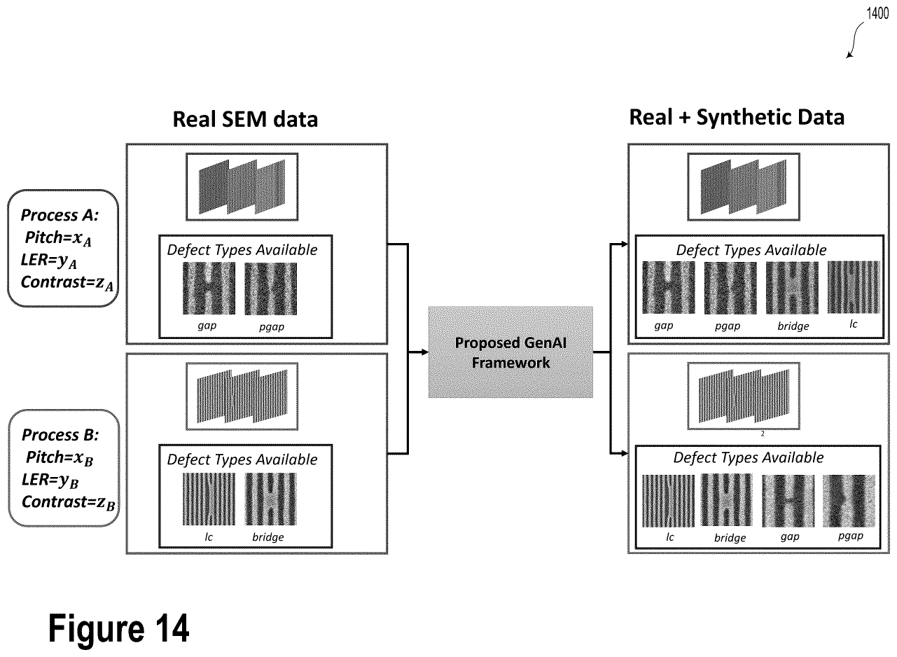

To mitigate this, the proposed approach has been examined whether it can generate instances outside of the extent of corresponding defect type's typical process context. In this way, the proposed generative model can be trained on different processes and their associated defect types concurrently. Afterwards, defect instances can be generated for a process where the given type has not been encountered yet (or encountered in limited numbers). This generated dataset can then be used to train ML-based defect detectors towards detecting the given defect types in the new environment. FIG. 14 illustrates a framework that can generate defect types outside its typical process parameters, to prepare defect detectors for unexpected scenarios, according to an example embodiment. The proposed approach manages to successfully generate defect instances outside of the process parameters they were encountered in during training.

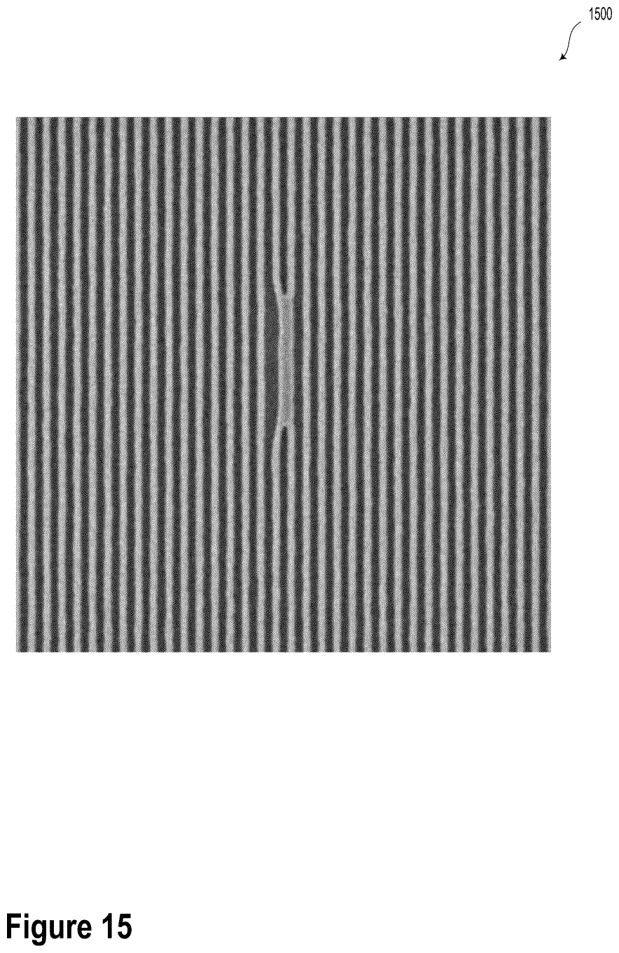

FIG. 15 is an SEM image with a line collapse defect, according to an example embodiment.

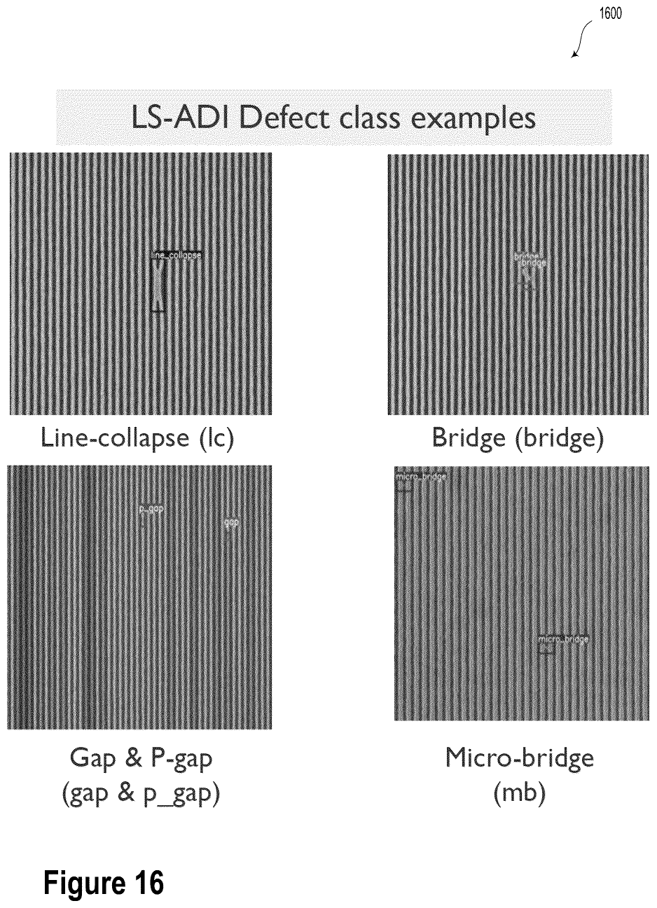

FIG. 16 illustrates several different defects from the LS-ADI test dataset, according to an example embodiment.

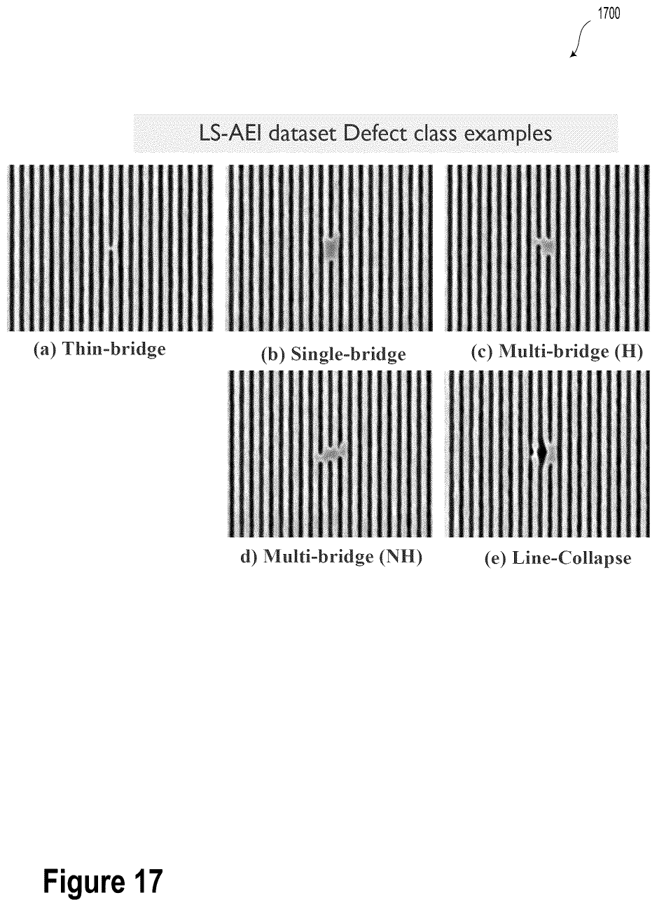

FIG. 17 illustrates several different defects from the LS-AEI test dataset, according to an example embodiment.

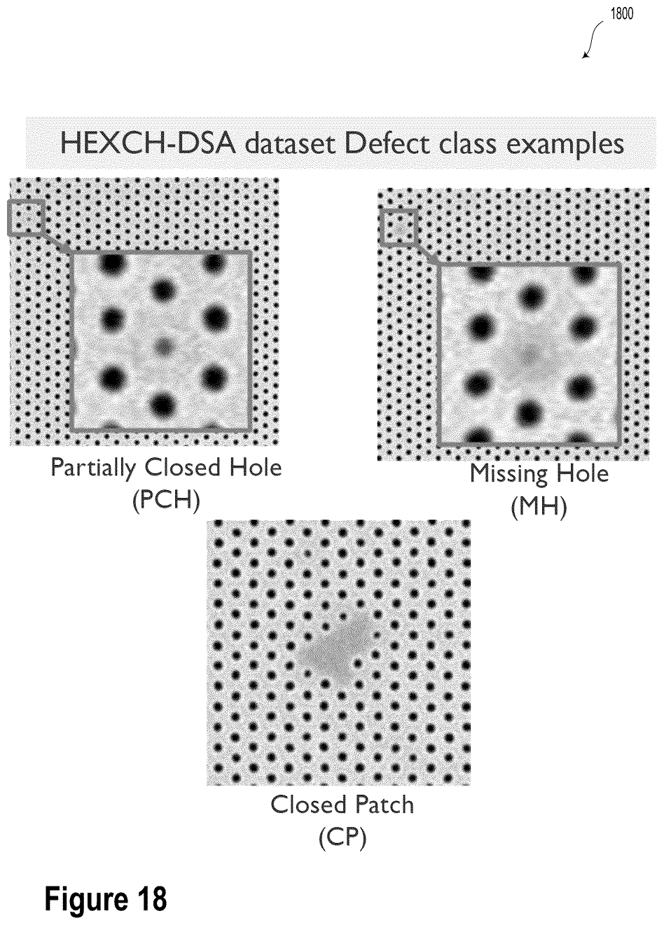

FIG. 18 illustrates several different defects from the HEXCH-DSA test dataset, according to an example embodiment.

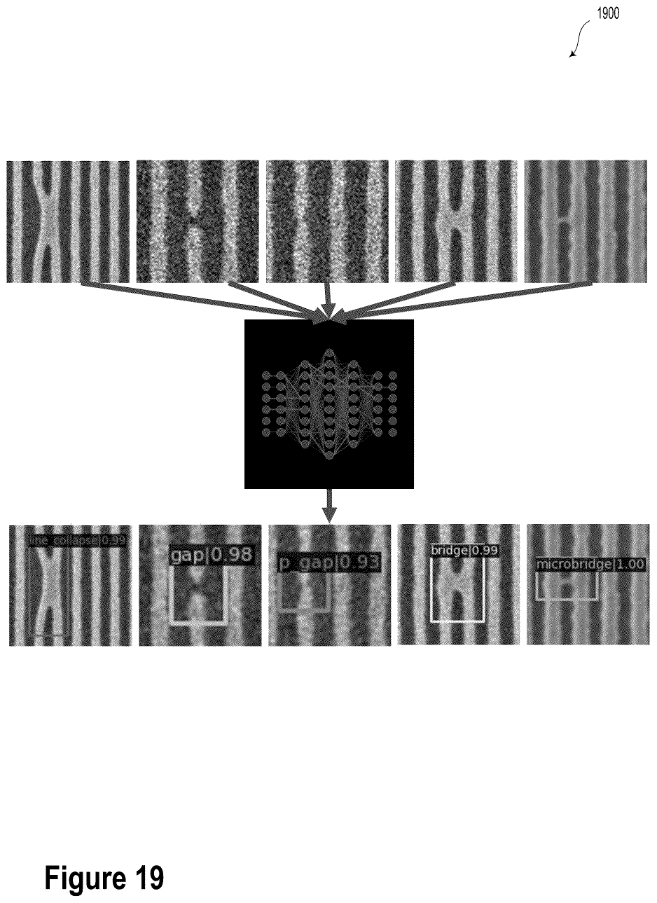

FIG. 19 illustrates the defect detection and classification process, according to an example embodiment.

In some examples, methods and systems described herein may include a hybrid model, which could combine a Physics-Informed Neural Network (PINN) with the presently-described generative models. Such a hybrid model may incorporate interaction of electron beams with the semiconductor material, material properties, pattern structures etc. to ensure that the generated images are consistent with physical principles.

### III. Example Methods

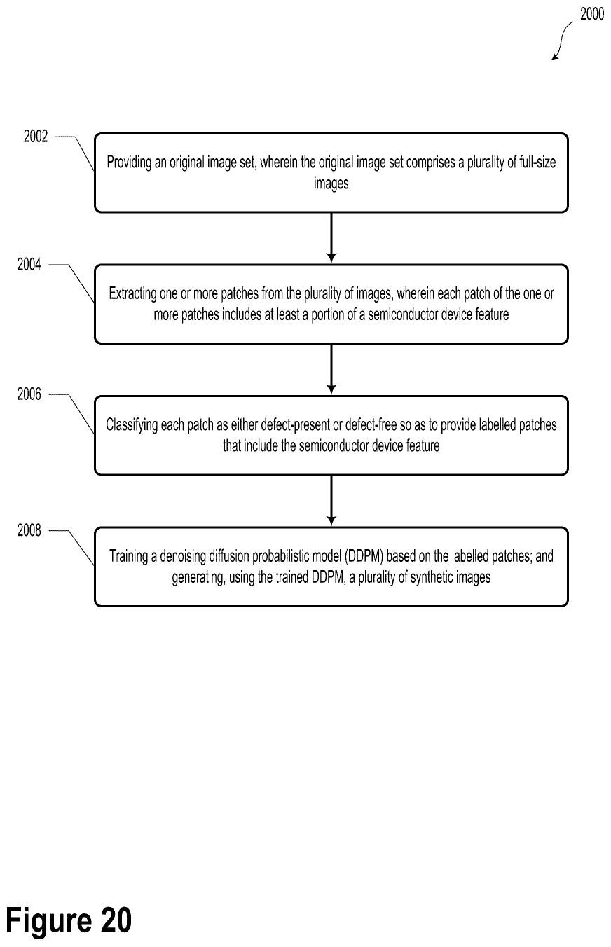

FIG. 20 illustrates a method 2000, according to an example embodiment. The embodiments of FIG. 20 may be simplified by the removal of any one or more of the features or blocks shown therein. Further, these embodiments may be combined with features, blocks, aspects, and/or implementations of any of the previous figures or otherwise described herein.

Block 2002 includes providing an original image set. In such scenarios, the original image set includes a plurality of full-size images (e.g., scanning electron microscope (SEM) images). In various embodiments, the full-size images have an image size of 1280×960 pixels or larger. In some examples, providing the original image set may include providing a plurality of images from at least one of: an LS-ADI real test dataset, an LS-AEI real test dataset, or a HEXCH-DSA real test dataset. It will be understood that other image sizes are possible and contemplated. In some examples, image types/sizes could include: LS-ADI (1024×1024), HEXCH (1024×1024 or 2048×2048), AEI (480×480, 512×512, etc.). Other image resolutions are possible, such as 256×256, 512×512, 1024×1024, 2048×2048. In some cases, images and/or generated images described herein could include resolutions up to 8192×8192 or more. In some examples, the images could be processed within about 10-20 ms using various backbones/models.

Block 2004 includes extracting one or more patches from the plurality of SEM images. In some embodiments, each patch of the one or more patches includes at least a portion of a semiconductor device feature. In various examples, extracting one or more patches can include extracting portions of the images having a default image size of 128×128 pixels, 256×256 pixels, or 512×512 pixels.

Block 2006 includes classifying each patch as either defect-present or defect-free so as to provide labelled patches that include the semiconductor device feature. In such scenarios, if a respective patch is classified as having a defect, classifying the defect as having a defect type from among a set of possible defect types.

Block 2008 includes training a denoising diffusion probabilistic model (DDPM) based on the labelled patches. In example embodiments, training the DDPM could include using a cosine noise schedule and 1000 sample steps. Additionally or alternatively, training the DDPM could include using a learning rate of between 0.001 and 0.00001 until convergence (e.g., 0.0001).

Block 2010 includes generating, using the trained DDPM, a plurality of synthetic images. In some embodiments, generating the plurality of synthetic images could include generating a plurality of full-size synthetic images. In such scenarios, each synthetic image of the plurality of synthetic images could include at least one defect from a corresponding defect type. In some examples, generating each synthetic image of the plurality of synthetic images includes selecting a desired defect type, generating an initial patch, and inpainting a portion of the initial patch with a simulated defect of the desired defect type. In embodiments, generating each synthetic image of the plurality of synthetic images could also include incrementally repeating the inpainting step with subsequent patches based on output from the DDPM so as to increase the size of the overall patch until a full-size output image is provided. It will be understood that in some embodiments, any region of interest (e.g., a patch either containing a defect instance/type or a patch that include no defects) can be utilized to start (described herein as an “initial patch”) and then generate a full size image. In other words, the method can utilize any random patch and generate a full version image.

Running a diffusion model on full size images (e.g., such as 512×512, 1024×1024, 2048×2048, etc.) is very extensive time-consuming and requires many graphics processing units (e.g., 100 or more), which is not desirable. Accordingly, the methods described herein relate to designating small patches around defects as well as small patches around non-defect image areas. These small patches may include a resolution of, for example, 128×128 or 256×256 and, using image inpainting, may generate a higher resolution image, e.g., 512×512, 1024×1024, 2048×2048, etc. using much fewer computing resources. The approach described herein also avoids the need for time-consuming and resource-intensive multi-resolution training.

In various example embodiments, generating the plurality of synthetic images could be performed without prior knowledge of Best-Known-Methods (BKM) relating to various tool imaging conditions.

In some examples, method 2000 could also include training a defect detector with the plurality of synthetic images to detect defects from one or more defect types. In such scenarios, training the defect detector could include training at least one of: a YOLOv5n model or a YOLOv4-CSP model.

In example embodiments, method 2000 may also include determining, using the trained defect detector, whether a defect is present in the plurality of synthetic images. Additionally or alternatively, method 2000 could include classifying each synthetic image of the plurality of synthetic images as either defect-present or defect-free so as to obtain labelled synthetic images.

In some examples, method 2000 could also include determining, using the trained defect detector, whether a defect is present in a plurality of real SEM images. Additionally or alternatively, method 2000 could include classifying each real SEM image of the plurality of real SEM images as either defect-present or defect-free so as to obtain labelled real SEM images.

In various embodiments, method 2000 could include determining, based on the labelled synthetic images and the labelled real images, performance metrics for detecting one or more selected defects and defect types within the respective labelled synthetic images and the labelled real images.

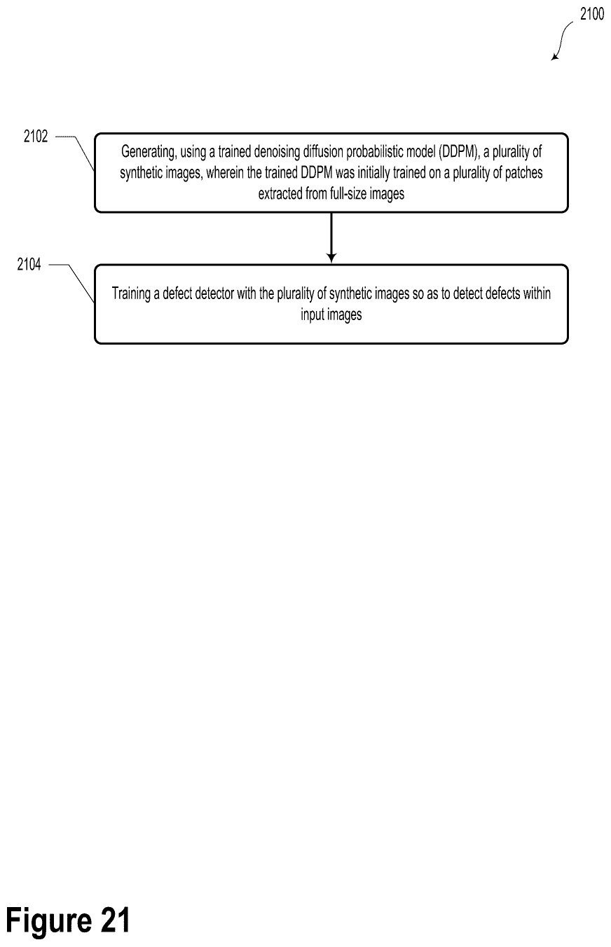

FIG. 21 illustrates a method 2100, according to an example embodiment. The embodiments of FIG. 21 may be simplified by the removal of any one or more of the features or blocks shown therein. Further, these embodiments may be combined with features, blocks, aspects, and/or implementations of any of the previous figures or otherwise described herein.

Method 2100 relates to training a defect detector. Method 2100 could include, for example, generating a dataset of defect images, which may include one or multiple defect instances. A labeling software such as labeling could be utilized to manually annotate each image according to an expert opinion for determining each defect definition. In this step, varying levels of annotator expertise can affect the training data. For example, variations in bounding box definition or pixel-wise annotation size/precision may cause inconsistency and/or labeling errors. These factors may affect the performance of the trained object detector. In some examples, these variations in image labeling can help the defect detector become more robust and generalized. Following image labeling, based on dataset imaging conditions such as grayscale image with noise, contrast, illumination, etc., the hyperparameters of the model can be adjusted. The hyperparameters could include, for example, hue, saturation, value, illumination, also general augmentation strategies like rotation, shear, flip etc. The hyperparameters could also include learning rate, early stopping criteria (to avoid overfitting etc.). In some examples, the model could be trained from scratch (e.g., using random weights) or using pre-trained weights. For example, the pre-trained weights could be used from a previously trained model trained using a large dataset of other objects. Then, using the new images, the model may be fine-tuned. Thereafter, the trained object detector may be evaluated and/or adjusted for desired accuracy on a validation dataset or test dataset.

Block 2102 includes generating, using a trained denoising diffusion probabilistic model (DDPM), a plurality of synthetic images. In such scenarios, the trained DDPM was initially trained on a plurality of patches extracted from full-size images (e.g., scanning electron microscope (SEM) images). In some embodiments, the DDPM model can be trained using any relevant images (e.g., independent of process or tool).

Block 2104 includes training a defect detector with the plurality of synthetic images so as to detect defects within input images. In some embodiments, training the defect detector includes training at least one of: a YOLOv5n model or a YOLOv4-CSP model.

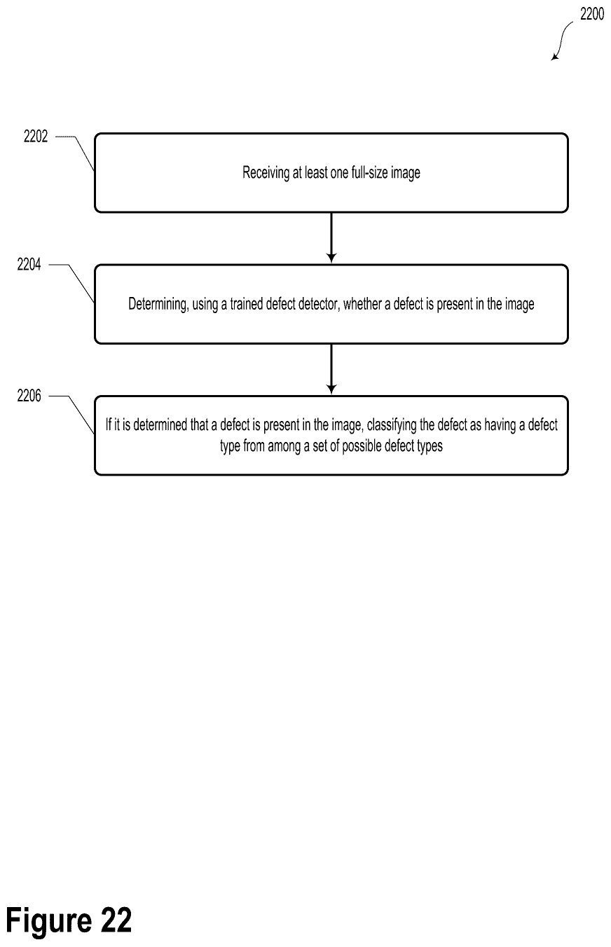

FIG. 22 illustrates a method 2200, according to an example embodiment. The embodiments of FIG. 22 may be simplified by the removal of any one or more of the features or blocks shown therein. Further, these embodiments may be combined with features, blocks, aspects, and/or implementations of any of the previous figures or otherwise described herein.

Method 2200 relates to detecting defects in semiconductor devices.

Block 2202 includes receiving at least one full-size image (e.g., a scanning electron microscope (SEM)).

Block 2204 includes determining, using a trained defect detector, whether a defect is present in the image. In such scenarios, the trained defect detector was trained using a plurality of synthetic images generated from a trained denoising diffusion probabilistic model (DDPM).

Block 2206 includes, if it is determined that a defect is present in the image, classifying the defect as having a defect type from among a set of possible defect types.

In some embodiments, method 2200 also includes determining, based on the plurality of synthetic images and the at least one image, performance metrics for successfully detecting one or more selected defects and defect types within the at least one image.

The present disclosure describes how an application of DDPM has been investigated for semiconductor defect detection. First, a patch-based approach was formulated to generate full-size wafer images. Afterwards, the quality of the generated synthetic images is examined in comparison to the metrology specifications of real images. Line-scan plots of real and synthetic images were compared and showed no significant differences in relevant parameters. Subsequently, the defect detector model was trained on these generated synthetic images under different conditions to further validate the applicability of synthetic images within a robust defect inspection framework. This addresses industrial challenges, such as class imbalance and data insufficiency, especially for the stochastic defect dataset in real resist wafer images. This dataset is not only rare and noisy but also very expensive to collect, making synthetic data valuable in facilitating the training of machine learning models. Significant performance improvements have been demonstrated for both the HEXCHDSA dataset and the LS dataset in both process steps, namely ADI and AEI, while using synthetically generated images during training. Notably, training on combined real and synthetic data improved mAP by 6.9% on HEXCH-DSA and improved AP on missing hole defect class by 19%. Finally, it is demonstrated that the proposed approach can generate defect types outside their typical environment, and a framework for ‘pattern transfer’ is proposed.

The particular arrangements shown in the Figures should not be viewed as limiting. It should be understood that other embodiments may include more or less of each element shown in a given Figure. Further, some of the illustrated elements may be combined or omitted. Yet further, an illustrative embodiment may include elements that are not illustrated in the Figures.

A step or block that represents a processing of information can correspond to circuitry that can be configured to perform the specific logical functions of a herein-described method or technique. Alternatively or additionally, a step or block that represents a processing of information can correspond to a module, a segment, a physical computer (e.g., a field programmable gate array (FPGA) or application-specific integrated circuit (ASIC)), or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods of time. Thus, the computer readable media may include secondary or persistent long term storage, like read only memory (ROM), optical or magnetic disks, compact-disc read only memory (CD-ROM), for example. The computer readable media can also be any other volatile or non-volatile storage systems. A computer readable medium can be considered a computer readable storage medium, for example, or a tangible storage device.

While various examples and embodiments have been disclosed, other examples and embodiments will be apparent to those skilled in the art. The various disclosed examples and embodiments are for purposes of illustration and are not intended to be limiting, with the true scope being indicated by the following claims.

What is claimed is:

1. A method comprising:
providing an original image set, wherein the original image set comprises a plurality of full-size images;
extracting one or more patches from the plurality of images, wherein each patch of the one or more patches includes at least a portion of a semiconductor device feature;
classifying each patch as either defect-present or defect-free so as to provide labelled patches that include the semiconductor device feature;
training a denoising diffusion probabilistic model (DDPM) based on the labelled patches; and
generating, using the trained DDPM, a plurality of synthetic images.

2. The method of claim 1, further comprising:
if a respective patch is classified as having a defect, classifying the defect as having a defect type from among a set of possible defect types.

3. The method of claim 1, wherein the full-size images have an image size of 1024×1024 pixels or larger.

4. The method of claim 1, wherein providing the original image set comprises providing a plurality of images from at least one of: an LS-ADI real test dataset, an LS-AEI real test dataset, or a HEXCH-DSA real test dataset.

5. The method of claim 1, wherein extracting one or more patches comprises extracting portions of the images having a default image size of 128×128 pixels, 256×256 pixels, or 512×512 pixels.

6. The method of claim 1, wherein training the DDPM comprises using a cosine noise schedule and between 100 to 10,000 sample steps.

7. The method of claim 1, wherein training the DDPM comprises using a learning rate of between 0.001 and 0.00001 until convergence.

8. The method of claim 1, wherein generating the plurality of synthetic images comprises generating a plurality of full-size synthetic images, wherein each synthetic image of the plurality of synthetic images comprises at least one defect from a corresponding defect type.

9. The method of claim 1, wherein generating each synthetic image of the plurality of synthetic images comprises:
selecting a desired defect type;
generating an initial patch; and
inpainting a portion of the initial patch with a simulated defect of the desired defect type.

10. The method of claim 9, wherein generating each synthetic image of the plurality of synthetic images further comprises:
incrementally repeating the inpainting step with subsequent patches based on output from the DDPM so as to increase the size of the patch until a full-size output image is provided.

11. The method of claim 1, wherein generating the plurality of synthetic images is performed without prior knowledge of SEM tool imaging conditions.

12. The method of claim 1, further comprising:
training a defect detector with the plurality of synthetic images to detect defects from one or more defect types.

13. The method of claim 12, wherein training the defect detector comprises training an object detection model that utilizes a cross stage partial (CSP) network.

14. The method of claim 12, further comprising:
determining, using the trained defect detector, whether a defect is present in the plurality of synthetic images; and
classifying each synthetic image of the plurality of synthetic images as either defect-present or defect-free so as to obtain labelled synthetic images.

15. The method of claim 12, further comprising:
determining, using the trained defect detector, whether a defect is present in a plurality of real SEM images; and
classifying each real image of the plurality of real images as either defect-present or defect-free so as to obtain labelled real images.

16. The method of claim 12, further comprising:
determining, using the trained defect detector, whether a defect is present in the plurality of synthetic images;
classifying each synthetic image of the plurality of synthetic images as either defect-present or defect-free so as to obtain labelled synthetic images;
determining, using the trained defect detector, whether a defect is present in a plurality of real SEM images;
classifying each real image of the plurality of real images as either defect-present or defect-free so as to obtain labelled real images; and
determining, based on the labelled synthetic images and the labelled real images, performance metrics for detecting one or more selected defects and defect types within the respective labelled synthetic images and the labelled real images.

17. A method for training a defect detector, the method comprising:
generating, using a trained denoising diffusion probabilistic model (DDPM), a plurality of synthetic images, wherein the DDPM was initially trained on a plurality of patches extracted from full-size images; and
training a defect detector with the plurality of synthetic images so as to detect defects within input images.

18. The method of claim 17, wherein training the defect detector comprises training an object detection model that utilizes a cross stage partial (CSP) network.

19. A method for detecting defects in semiconductor devices, the method comprising:
receiving at least one full-size image;
determining, using a trained defect detector, whether a defect is present in the image; and
if it is determined that a defect is present in the image, classifying the defect as having a defect type from among a set of possible defect types.

20. The method of claim 19, further comprising:
determining, based on the plurality of synthetic images and the at least one SEM image, performance metrics for successfully detecting one or more selected defects and defect types within the at least one image.

21. The method of claim 19, wherein receiving at least one full-size image comprises receiving an image with an image size of 1024×1024 pixels or larger.
